(19) United States
(12) Patent Application Publication
(10) Pub. No.: US 2026/0364698 A1
(43) Pub. Date: Nov. 19, 2026

(54) METHOD FOR PRODUCING A HIGH-TEMPERATURE-RESISTANT INTEGRAL BOND

(71) Applicant: Endress+Hauser Wetzer GmbH+Co. KG, Nesselwang (DE)

(72) Inventor: Hubert Szymczak, Nesselwang (DE)

(21) Appl. No.: 19/477,236

(22) PCT Filed: Apr. 16, 2024
(86) PCT No.: PCT/EP2024/060300

§ 371 Date: Oct. 21, 2025

(30) Foreign Application Priority Data
Apr. 21, 2023 (DE) 10 2023 110 235.4

(51) Int. Cl. B23K 1/00; B23K 9/00; B23K 101/38

(52) U.S. Cl. CPC B23K 1/0016; B23K 9/00; B23K 2101/38

(57) ABSTRACT

A method for producing a high-temperature-resistant integral bond between a conductor element and a connecting part includes: providing the conductor element; providing the connecting part having a, in particular cylindrical, guide for receiving the conductor element; providing an annular element; inserting the conductor element into the guide, wherein the conductor element inserted into the guide, the annular element, and the connecting part are arranged relative to one another such that the annular element abuts both a first joining surface of the outer casing and a second joining surface of the connecting part; and joining by means of a thermal joining process, during which the annular element is completely melted and an integral bond is produced between the conductor element and the connecting part.

The invention relates to a method for producing a high-temperature-resistant integral bond, in particular one that is temperature-resistant at temperatures of at least 380 °C, preferably at least 700 °C, between a conductor element and a connecting part. Furthermore, the invention relates to a high-temperature-resistant assembly, in particular one that is temperature-resistant at temperatures of at least 380 °C, preferably at least 700 °C.

Field devices in automation technology, especially industrial temperature measuring devices or their process-related components used to record the process variable, are constructed for high-temperature use using so-called mineral-insulated sheathed cables (also: mineral-insulated cables or mineral-insulated lines, in short, MI lines or MIL). These are specifically designed for high-temperature use and are typically exposed to corrosive and mechanical stress when used as intended. In addition to the above-mentioned use in temperature measurement technology, MI lines are also used in signaling technology and/or heating technology.

MI lines typically comprise a tubular element with an outer casing, inside which inner conductors (usually 1 to 8) extend, particularly parallel to the cylinder axis of the outer casing. The outer casing is typically made of a metal (e.g., stainless steel, nickel-based alloy, copper, etc.) and has an outer diameter in the range of 0.5 to 10.0 mm. The inner conductors are insulated from the outer casing and, if necessary, from each other by means of a compact insulating material, for example, by being pressed into a metal oxide powder, especially a highly compressed one, e.g., MgO, Al2O3, SiO2. The inner conductors can have different diameters depending on the MI lines type. Depending on the type of powder, it can be of varying hygroscopicity and/or density, have varying grain sizes, have a different degree of dryness, and/or may contain chemically bound (residual) water.

Such a conductor element is then cut to the appropriate length, for example when constructing a thermometer measuring insert, and the inner conductors are exposed over a certain length. Then a corresponding temperature sensor element is soldered or welded in a two-, three-or four-wire circuit. The inner conductors are made, for example, of a thermal material (when the MI lines are used as connection lines for a thermocouple as the temperature sensor element) or of a Cu—Ni or Ni—Cr alloy, Ni-plated copper, Ni, or Cu (when the MI lines are used as connection lines for a PTC thermistor, e.g., a Pt100, as the temperature sensor element).

The outer casing is also often joined to a connecting part, in particular a metal one, by means of an additional bond. The connecting part has a guide, e.g., designed as a hole, into which the conductor element is pushed. Connecting an MI lines to the connecting part by means of the additional integral bond enables the installation of the MI line, e.g., for temperature measurement, in a technical system, in particular a process system in automation technology. The technical system typically comprises a container, such as a (pressure) vessel, silo, pipeline, etc., with a medium arranged therein—e.g., a fluid (gas, liquid) or a solid substance. This (further) bond therefore serves the purpose of mechanically connecting the conductor element with the connecting part and in particular not (also) of electrically contacting the conductor element. The bond should therefore be designed to be sealed against the medium.

Various joining techniques for realizing the above-mentioned, in particular non-detachable, bond between a mineral-insulated sheathed cable and a connecting part are known from the prior art. The bond is usually frictionally engaging and/or integral. A particular challenge, especially for high-temperature applications, is that the components of an MI line (outer casing, insulation material, inner conductor) and, if applicable, the connecting part comprise different materials and therefore have different physical properties, especially heat capacities and thermal conduction coefficients.

Frictionally engaging bonds include crimping, for example, where the connecting part is pushed onto the MI lines and overlaps it. The connecting part is deformed, in particular pressed, at several points on the two joining partners in an overlapping area (also: circumference). In this way, both dissimilar (MI lines and connecting part consist of different base materials) and similar (MI lines and connecting part consist of the same or very similar base materials) material combinations can be connected. Such purely frictionally engaging bonds have the following disadvantages
depending on the degree/type of deformation at the crimping point, one or more gaps may form, which may cause corrosion at the bond upon contact with the process medium. As a result, the bond may no longer be sufficiently media-tight, in particular no longer sufficiently gas-tight.
During crimping, the connection point is crushed, which results in deformation of the MI line. This may lead to non-compliance with required specifications, in particular according to corresponding standards, e.g., IEC 61515 and/or ASTM E585/E585M, e.g., regarding minimum distances between the inner conductors and/or between the inner conductors and the outer casing.

Integral connections include gluing, soldering and welding, although thermal processes are usually preferred. The amount of heat supplied during welding is usually much greater than with soldering.

With soldering, the two joining partners usually remain in the solid phase and are not melted. Soldering is primarily based on diffusion processes and requires the addition of a solder of which the liquidus temperature is lower than the solidus temperature of the joining partners and has a different chemical composition than the two joining partners. For example, a joint gap is provided between the MI line and the connecting part, into which gap the solder can flow during soldering. The solder is usually supplied as a wire, as a solder preform or in the form of a paste. In this way, both similar and dissimilar material combinations can be combined. Soldering between an MI line and a connecting part requires special surface preparation, e.g., using a flux, to enable wetting of the surfaces to be wetted with solder. Soldering is used for smaller dimensions of MI lines, especially for dissimilar base material combinations or as an alternative to laser welding of similar base material combinations and small dimensions. The soldering processes known from the prior art for producing an integral connection between an MI line and a connecting part have the following disadvantages:
Pore formation: Prior-art solder joints often have pores (internal) or pores open towards the surface, which then impair the strength of the connection or lead to leaks.
Many of the solder joints known from the prior art are unsuitable for use in the high temperature range, since the remelting temperature of the solder joint often corresponds to the liquidus temperature. In this case, at an operating temperature above the liquidus temperature, the connection between the MI line and the connecting part may become leaky or even come loose.

Welding creates permanent, integral bonds that are created by applying heat (fusion welding process) and/or pressure (pressure welding process), with or without the addition of a welding filler material. Fusion welding processes are commonly used to connect MI lines to a connecting part, in particular arc welding processes (TIG welding, (micro) plasma welding) and beam welding processes (laser beam welding). In fusion welding processes, heat is supplied from the outside until the base materials and, if applicable, the welding filler material melt.

The welding filler material can make welding easier or even make it possible in the first place, wherein in the case of similar base material combinations, welding does not necessarily have to be performed with a welding filler material, whereas in the case of dissimilar base material combinations, welding is usually performed with a welding filler material. The selection of the welding filler material is then based on the more noble (higher alloyed) base material of the two joining partners. The welding filler material for joining MI line with a connecting part is usually fed to the arc or beam at the welding line in the form of a rod (e.g., manual TIG welding, manual (micro) plasma welding, manual laser beam welding) or a wire (mechanized and automated arc welding processes (e.g., TIG, MIG/MAG), laser beam processes, electron beam processes). The diameter of the welding rod or wire is selected in relation to the wall thicknesses to be welded (MI line and connecting part) as well as the required weld seam thickness. For smaller wall thicknesses (and diameters), thinner welding fillers (<0.5 mm) must be used due to process control and stability. These are either available as special sizes or are not available on the market. The welding filler material can be added to the welding point in the form of a powder. It is completely melted, mixes with the two melted areas of the MI line and the connecting part and forms a weld pool, which forms a weld seam after solidification (falling below the solidus temperature). In the above-mentioned manual welding processes, the two joining partners are not moved (rotated) during welding. In the above-mentioned mechanized/automated welding processes, the two joining partners are rotated either in a mechanized manner or manually. The welding processes are generally used for medium and larger MI line (e.g., diameter >=5.0 mm), since with these dimensions the welding process can be implemented somewhat more stably due to the controlled heat input. When welding MI lines to a connecting part, in-process control of the heat input (the welding energy) is of utmost importance.

Fusion welding (arc welding, beam welding) of MI lines with a connecting part (with identical or dissimilar base material combinations, with or without welding filler material, manually or automatically) often leads to weld seam irregularities. The weld quality can vary and, in extreme cases, even lead to the destruction of the outer casing of the MI line during welding, burn-through and/or the formation of open pores extending all the way to the surface. The reasons for this are the different properties of the MI lines, such as fluctuating outer casing thicknesses along the entire length of the MI line due to the manufacturing process and/or the differences in heat capacities and thermal conduction coefficients mentioned above. In addition, the properties of the insulating material, such as grain size, density (degree of compaction), purity of the powder, (residual) water content, vary depending on the insulating material or dimension, type and/or manufacturer of the MI line. All these parameters influence the stability of the welding process. Furthermore, the MI lines often have to be heated in an oven before welding in order to remove the residual water content from the insulating material or to reduce it sufficiently. When joining the MI line and the connecting part, it is therefore important to ensure that the two joining partners have a close tolerance pairing before welding, so that the gap between them is as small as possible in order to make the welding process easier to control, especially with regard to the locally introduced heat (heat conduction). The air in the gap here acts as a thermal insulator. In addition, excessively large gaps can lead to cracks in the root area of the weld seam; these are unacceptable and should therefore be avoided in principle. When using welding filler materials, attention must be paid to precise welding filler material feeding (position of the welding filler material to the welding line) in order to avoid possible (often unacceptable) irregularities in the weld joint (e.g., lack of fusion, burn-through through the MI line, root over-arching/under-arching in butt welds, excessive seam over-arching, etc.). In addition, the thickness (diameter) of the welding filler material must be adapted to the dimensions of the relatively small MI lines (small outer diameters, low casing thicknesses) and the connecting parts, as well as the required weld seam thickness. The dimensions of the available welding filler materials (rods, wires, wire electrodes, etc.) are standardized (EN ISO 544); smaller diameters (<0.5 mm) are either not available at all or only available on request as custom-made products (typically in small quantities and therefore correspondingly more expensive).

It is therefore the object of the invention to provide an improved joining method which does not have the weaknesses of the above-mentioned joining methods or at least greatly reduces them. The joining process should be independent of the geometric and physical properties of the MI line and the connecting part and be suitable for both arc and beam welding and, in particular, for both dissimilar and similar base material combinations and all common weld seam types (fillet welds, butt welds, bead-shaped welds, etc.).

The object is achieved by a method for producing a high-temperature-resistant integral bond and a high-temperature-resistant assembly with an integral bond between a conductor element and a connecting part.

With regard to the method, the object is achieved by a method for producing a high-temperature-resistant integral bond, in particular one that is temperature-resistant at temperatures of at least 380 °C, preferably at least 700 °C, between a conductor element and a connecting part, the method comprising the steps of:
providing the conductor element, the conductor element comprising:
   a tubular element with an outer casing, in particular a metal one;
   at least one inner conductor arranged inside the tubular element, in particular at least two inner conductors;
   an insulating material which is arranged inside the tubular element and which serves to electrically insulate at least the tubular element from the at least one inner conductor;
providing the connecting part, in particular which is metal at least in regions, the connecting part having a guide, in particular a cylindrical guide, for receiving the conductor element;
providing an annular element;
inserting the conductor element into the guide,
wherein the conductor element inserted into the guide, the annular element and the connecting part are arranged relative to one another in such a way that the annular element abuts both
   a first joining surface of the outer casing, in particular an end face and/or the casing surface of the outer casing, and
   a second, in particular metal, joining surface of the connecting part, in particular an end face or a casing surface of the connecting part, in particular one which is cylindrical at least in portions; and
joining by means of a thermal joining process, during which joining process the annular element is completely melted and an integral bond is produced between the conductor element and the connecting part, in particular in the form of an annular round seam.

The bond produced by means of the method according to the invention serves in particular only for the mechanical connection between the conductor element and the connecting part, and typically not also for the production of an electrical connection between the inner conductors and the connecting element.

The connecting part is, for example, one of the following: a (threaded) connection, a bracket or fastening, a sleeve.

The metal connecting part comprises in particular at least one of the following: a stainless steel, a nickel-based alloy, copper or a copper alloy.

The bond can be either of a different type or of the same type.

The advantage of the method according to the invention is that the controlled and complete melting of the annular element creates an intact and defect-free (annular) bond which at the same time has a high temperature resistance.

In one embodiment of the method, the joining process comprises soldering, wherein during the soldering the annular element serves as a, in particular lead-free, solder preform, so that a solder connection is produced as the integral bond.

The solder preform is made, for example, of a composite material comprising a first composite component made of a solder alloy, in particular based on indium (In) or tin (Sn), which is arranged in a metal matrix forming the second composite component.

The second composite component is a metal with a high melting temperature, such as copper or silver or the metals mentioned in the scientific article cited below. The solder alloy is arranged in layers/levels in the metal matrix. The solder preform is preferably oriented during soldering in such a way that the layers or coatings are arranged substantially parallel to the two joining surfaces of the two joining partners. The solder preform is characterized in that during soldering, intermetallic phases are formed, which extend along the layers of the solder alloy. Due to the layered structure of the solder preform, the intermetallic phases are arranged in a direction perpendicular to the joining surfaces, which means that the solder connections produced with it have excellent mechanical strength and high temperature resistance. Such a preformed solder part is described in DE 10 2018 116 410A1 , DE 10 2019 122 611 A1 or the scientific article “Preform-based diffusion soldering for use under conventional soldering process parameters” by HM Daoud et al. (European Microelectronics and Packaging Conference (EMPC) & Exhibition, DOI 10.23919/EMPC.2017.8346889) and is manufactured and distributed by Pfarr under the name PFDS400®. A solder joint produced with the PFDS400® solder preform is high-temperature-resistant despite the low liquidus temperature of the solder preform of less than 250 °C. For example, a solder joint produced with a PFDS400® solder preform (with a tin-containing solder alloy) has a temperature resistance of at least 400 °C, i.e., well above the liquidus temperature mentioned above. Such a solder preform is therefore preferably used in this embodiment to form the annular element.

In one embodiment of the method, the joining process comprises welding, wherein during the welding the annular element serves as a welding filler material, so that a welded joint is produced as the integral bond.

In this embodiment, it is therefore preferable that no further welding filler material needs to be used, thus avoiding the disadvantages mentioned at the outset.

Regardless of whether (soft/hard) soldering or welding is used as the thermal joining process, the annular element produces a well-controllable and intact bond, especially in the form of an annular round seam.

In one embodiment of the method, a single-or multi-core mineral-insulated conductor (MI line) is used as the conductor element.

In one embodiment of the method, the annular element, the first joining surface and the second joining surface are metal, wherein the annular element is at least as highly alloyed as or more highly alloyed than the more highly alloyed of the two joining surfaces, wherein the annular element consists in particular of a nickel-based alloy or a stainless steel. This configuration is particularly preferred for the joining process comprising welding.

In one embodiment of the method, the annular element comprises a main body, wherein the main body is designed as a rotation body such that it is formed by an (imaginary) rotation, in particular with an angle of less than or at most equal to 360°, of an (imaginary) cross-sectional area (QF) about an (imaginary) rotation axis (RA), wherein the rotation axis (RA) lies in a plane with the cross-sectional area (QF) and does not intersect the cross-sectional area (QF), wherein a distance (AB) between the rotation axis (RA) and a center point of the cross-sectional area is greater than a diameter (DM) of the cross-sectional area, and wherein in particular the cross-sectional area is round, elliptical, circular, angular, triangular or rectangular.

For example, if the cross-sectional area is circular and the rotation angle is 360°, the torus is solid.

In one embodiment of the method
the diameter D of the cross-sectional area is at least 0.05 times, in particular 0.1 times, as large as a wall thickness of the outer casing and/or
the diameter of the cross-sectional area is at most as large as a wall thickness of the outer casing and in particular less than 0.5 times the wall thickness and/or
the distance is at least three times, in particular at least five times, as large as the diameter.

In one embodiment of the method, the conductor element and the annular element are arranged relative to one another before joining in such a way that the imaginary rotation axis substantially coincides with a cylinder axis of the conductor element.

In one embodiment of the method, the annular element is manufactured in the form of a separate element before joining and is subsequently provided.

In one embodiment of the method, the annular element is placed, in particular pushed, onto the outer casing and/or a casing surface of the connecting part before joining.

In one embodiment of the method, the annular element has at least one, in particular exactly one, projection which extends from an inner surface of the annular element, in particular an inner surface facing the rotation axis, in the direction of the first joining surface and/or the second joining surface, and wherein the projection has a height in the direction of the first joining surface and/or second joining surface which is at most as large as 0.1 times the diameter, in particular 0.05 times the diameter.

In one embodiment of the method, the main body is designed as a rotation body, which rotation body is formed by a rotation through an angle of less than 360°, in particular greater than 315°, preferably greater than 350°, so that the main body has a gap.

In one embodiment of the method, this includes the following steps to be performed before the joining:
fixing of the annular element at a predetermined joining position, in particular on the casing surface of the outer casing and/or a casing surface of the connecting part;
tacking the annular element at the joining position, wherein during the tacking, the annular element is only partially melted and only partially integrally connected to the conductor element and/or the connecting part, in particular at the at least the projection serving as a tacking point.

If necessary, the annular element is fixed using a tool before tacking.

In one embodiment of the method, the annular element sits in a press fit on the casing surface of the outer casing and/or a casing surface of the connecting part before the joining.

In one embodiment of the method, the annular element is integrally connected to the connecting part or the conductor element during the production of the annular element, so that an assembly comprising the annular element and the connecting part or conductor element integrally connected thereto is obtained before the joining. Unlike before, the annular element and one of the two joining partners are no longer separate, but rather components of a common assembly that are already integrally connected to one another. In this case, the tacking for example can be omitted.

In a development of the latter embodiment, the method comprises the following step to be performed before the joining:
providing the annular element by means of an additive manufacturing process, wherein the annular element during its manufacture is applied directly to the connecting part and/or the conductor element at a predetermined joining position by means of the additive manufacturing process, whereby the assembly comprising the annular element and the connecting part or conductor element integrally connected thereto is obtained before the joining.

In the additive manufacturing process (e.g., 3-D printing), e.g., according to the standard DIN EN ISO/ASTM 52900:2022-03, selective laser melting, electron beam melting and/or selective laser sintering are used. If necessary, the connecting part and the annular element are also manufactured in a common additive manufacturing process, in particular using different starting materials for the annular element and the connecting part.

In a development of the latter embodiment, the method comprises the following steps to be performed before the joining:
providing a starting material for the annular element;
providing a starting material for the connecting part, in particular comprising a stainless steel;
initially welding the starting material for the annular element with the starting material for the connecting part in a pressure welding process, in particular by means of diffusion welding, wherein an initial assembly is formed during the initial welding of the two starting materials,
wherein the starting material for the annular element has a smaller thickness in a pressing direction, which pressing direction is perpendicular to a welding surface of the pressure welding process, than the thickness of the starting material for the connecting part in the pressing direction,
and wherein in particular the thickness of the starting material for the annular element is at most 0.1, in particular at most 0.05 times, as large as the thickness of the starting material for the connecting part in the pressing direction; and
   manufacturing the annular element and the connecting part integrally connected thereto from the initial assembly, in particular by means of a manufacturing process from the main group of separating and/or forming, in particular by means of machining, cutting, turning, drilling, whereby the assembly comprising the annular element and the connecting part integrally connected thereto is obtained from the initial assembly before the joining.

In one embodiment of the method, the round seam between the conductor element and the connecting part is formed as a fillet seam, butt seam or a bead-shaped seam.

In one embodiment of the method, this comprises the following step, which step is performed after the conductor element has been inserted into the guide and before joining or before tacking and joining:
clamping an arrangement consisting of conductor element, connecting part and annular element in a clamping device,
rotating the arrangement for the case where the clamping device is a rotating device or rotating an energy source used in welding and/or tacking around the assembly, in the case where a movable energy source is used, during welding and/or tacking.

In one embodiment of the method, the tacking and/or welding is performed in a fusion welding process, in particular an arc welding process, in particular using a non-consumable electrode, or in a beam welding process.

In one embodiment of the method, the welding is free from the use of any further welding filler material different from the annular element.

In one embodiment of the method, the method comprises the following step:
using an energy source during welding, wherein the energy source is directed onto an arrangement consisting of a conductor element, a connecting part and the annular element in such a way that energy emitted by the energy source in the direction of the arrangement is absorbed to a large extent, in particular more than 85%, by the annular element.

The object is also achieved by a high-temperature-resistant assembly, in particular one that is temperature-resistant at temperatures of at least 380 °C, preferably at least 700 °C, comprising:
a conductor element and a connecting part,
wherein a high-temperature-resistant integral bond is present between the conductor element and the connecting part,
and wherein the high-temperature-resistant, integral bond is produced by means of the method according to the invention.

The invention will be explained further with reference to the figures, which are not true-to-scale, wherein the same reference signs designate the same features. For reasons of clarity, or if it appears sensible for other reasons, previously-noted reference signs will not be repeated in the following figures, in which:

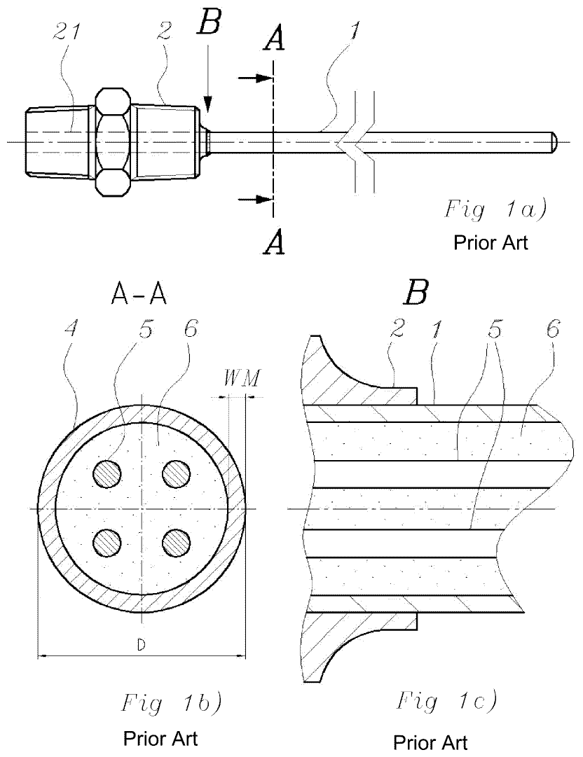

FIG. 1a) to 1c) are different views of a conductor element 1 and a connecting part 2 connected thereto according to the prior art;

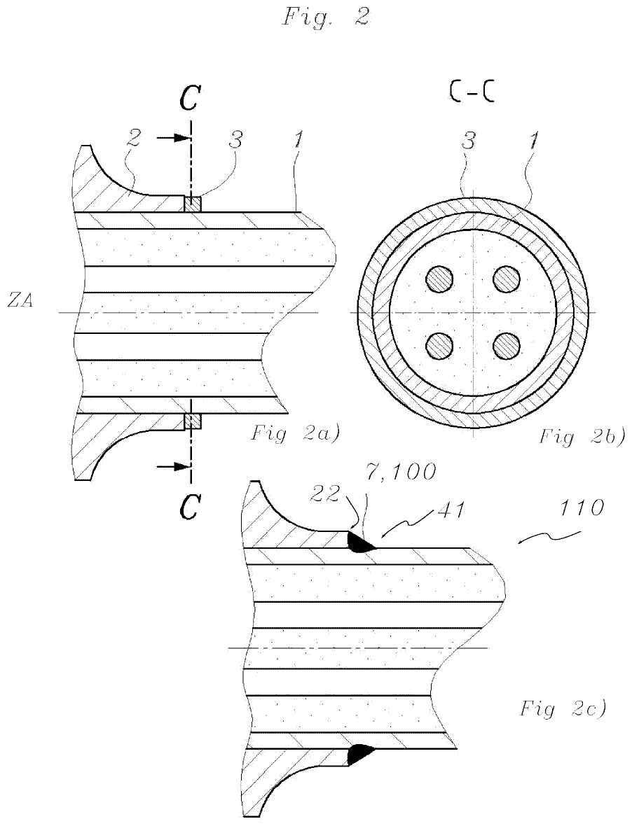

FIG. 2a) to 2c) are sectional views of a conductor element 1 and a connecting part 2, during the production of a bond 100 according to an embodiment of the method according to the invention;

FIGS. 3a) and b) are sectional views of a conductor element 1 and a connecting part 2, during the production of a bond 100 according to a further embodiment of the method according to the invention;

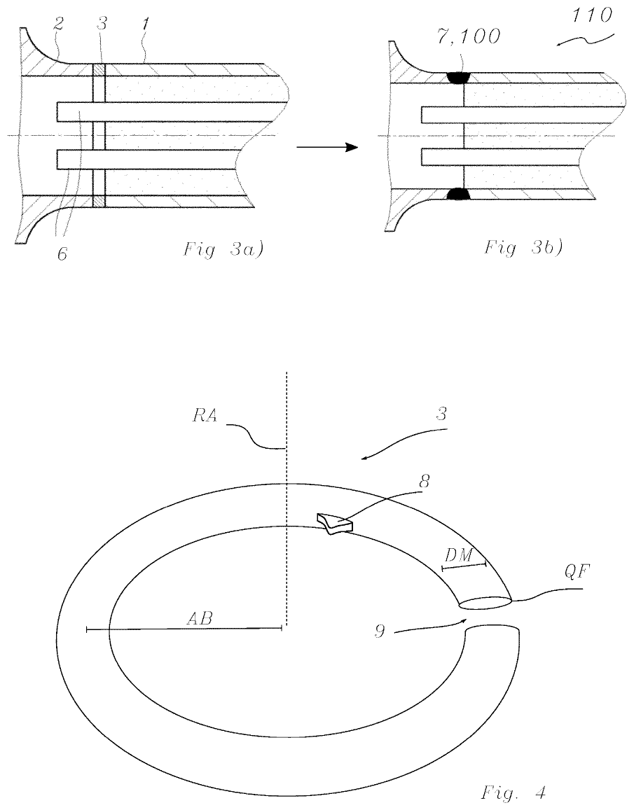

FIG. 4 is a perspective view of the annular element 3 as used in an embodiment of the method according to the invention;

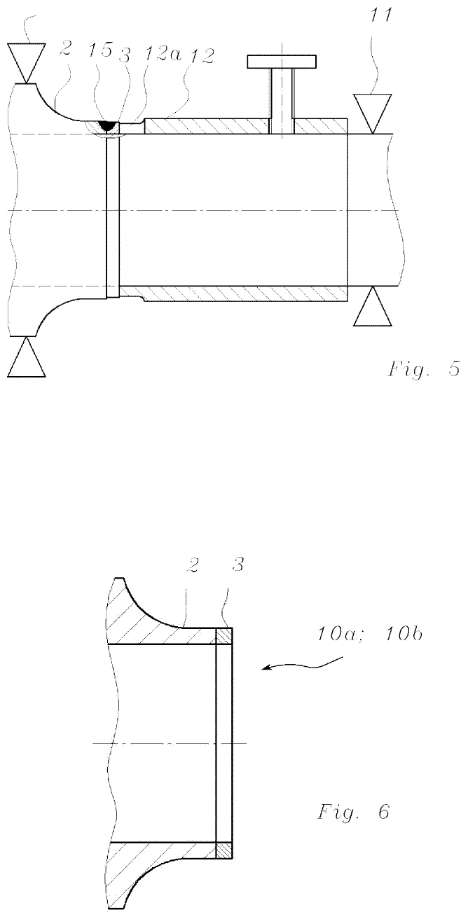

FIG. 5 is sectional views of a conductor element 1 and a connecting part 2, during the production of a bond 100 according to a further embodiment of the method according to the invention; and

FIG. 6 is a sectional view of a connecting part 2 and an annular element 3 integrally connected thereto in a further embodiment of the method according to the invention.

FIG. 1a) is a side view of a typical design of a conductor element 1 and a connecting part 2 connected thereto according to the prior art. The conductor element 1 is inserted into a cylindrical guide 21 of the connecting part 2. The connecting part 2 is a metal connection with a thread.

The conductor element 1 is an MI line, as shown in more detail in the sectional view in FIG. 1b).A plan view of a section of the conductor element 1 along the line of section A-A, see FIG. 1a, is shown. The MI line comprises the metal outer casing 4 and (here: four) inner conductors 5, which extend parallel to the outer casing 4. They are insulated from the outer casing 4 by means of an insulating material 6 (a highly compressed metal oxide powder, e.g., MgO, Al₂O₃, SiO₂). The conductor element 1 typically has an outer diameter D in the range of 0.5-10.0 mm. The wall thickness WM of the outer casing 4 is typically 5-20%, e.g., 10%, of the outer diameter D of the conductor element 1, whereas the wall thickness WM of the outer casing 4 can vary over the length of the entire MI line as a result of the manufacturing and subsequent processes. FIG. 1c) is a detail in the area B of FIG. 1a), namely the transition between the conductor element 1 and the connecting part 2. A casing surface of the conductor element 1 borders on an end face of the connecting part 2 in the region of a bond to be produced.

The method according to the invention explained in more detail below enables the production of an improved bond in region B. This is shown in more detail for a first embodiment of the method according to the invention in FIG. 2a) to c). The area already shown in FIG. 1c) now contains the annular element 3, which is designed, for example, as a solder preform or a welding filler material. The annular element 3 is pushed onto a casing surface of the outer casing 4 of the MI line up to a defined joining position.

A cross-section of the pushed-on annular element 3 along the line C-C is shown in FIG. 2b). At the joining position, the inner surface of the annular element 3 borders on the casing surface of the outer casing 4. In this embodiment, the casing surface thus forms a first joining surface 41.

Subsequently, the conductor element 1 with the annular element 3 pushed onto it (see FIG. 2a) is pushed into the guide 21 of the connecting part 2 until the connecting part 2 abuts the annular element 3 with an end face 22. The conductor element 1 is cylindrical, wherein a cylinder axis ZA of the conductor element 1 coincides with a longitudinal axis of the guide 21 of the connecting part 2, which is in particular cylindrical in portions.

The end face 22 of the connecting part 2 serves as the second joining surface 22. With such an arrangement, a round seam 7 is produced in the thermal joining process as a high-temperature-resistant, integral bond 100, which in this embodiment of the method according to the invention has the shape of a fillet seam. By means of the high-temperature-resistant, integral bond 100, an assembly 110 is obtained comprising integrally interconnected conductor element 1 and connecting part 2. During the thermal joining process, the complete melting of the annular element 3 results in an intact and flawless, integral bond 100 which is resistant to high temperatures. Welding is preferred as the thermal process, as welded joints generally have good high-temperature strength. Of course, the invention also encompasses soldering processes, wherein in the latter case, it must be ensured by appropriate selection of the solder preform that the bond 100 produced thereby is high-temperature resistant (this despite a possibly low liquidus temperature of the solder preform, see the composite material solder preform PFDS400® mentioned above in this context). For the sake of simplicity, the method according to the invention will be explained in more detail below in conjunction with welding processes, wherein the invention mutatis mutandis also, of course, includes soldering processes.

For welding, the assembly comprising conductor element 1, annular element 3, connecting part is clamped in a clamping device 11 (not shown here-see FIG. 5), for example a rotating device of a welding device, for example on the connecting part 2 or the conductor element 1, depending on the joining position. Clamping is achieved, for example, using a three-jaw chuck, collet system, or in another way. The other side of the assembly is supported on the conductor element 1 by means of a support (loosely mounted tailstock of a steady rest, or with a similar support system), wherein in the case of short lengths of the conductor element 1, work can be performed without a support.

Welding is performed either with an arc welding process with a non-consumable electrode (e.g., TIG welding, (micro) plasma welding) or with a beam welding process (e.g., laser beam welding), in each case without the use of a welding filler material in the conventional form (i.e., welding filler material in the form of wire, rod) additional to the annular element 3. The annular element 3 already functions as a welding filler material, so that preferably no additional welding filler material is required.

An energy source (arc, beam, ionized gas, the latter in the case of plasma welding) is directed onto the annular element 3 in such a way that the primary energy absorption occurs by the annular element 3. Furthermore, in the arc welding processes or beam welding processes, the welding position (angular position) and the size of the arc (over the distance and in combination with the electrode diameter) or the beam (focus diameter) are selected so that complete melting of the annular element 3 and the weld seam flanks can take place. In arc welding processes with non-consumable electrodes, the process can be either mechanized/automatic or manual. In beam welding processes, the process is usually mechanized/automatic. The two welding process types can run in pulsed mode or in continuous mode. The arc or beam energy can be modulated during welding.

The invention further includes welding by means of TIG orbital welding, an arc welding process with a non-consumable electrode, in which the assembly to be welded is not moved, but the arc (welding torch) moves around the—preferably rotationally symmetrical—assembly. TIG orbital welding has the advantage that long MI lines do not have to be unwound from a spool (also: coil, the usual delivery form of MI lines) and/or completely straightened. This is because no simple rotation of the MI line is necessary during TIG orbital welding. The conductor element 1 only needs to be straightened up to a joining position adjacent to the connecting part 2. In addition, the joining process in TIG orbital welding is largely automated, so that this welding process is preferably used in the method according to the invention.

The assembly prepared for welding (conductor element 1, connecting part 2, annular element 3) is aligned, fixed and closed in a fixed clamping device 11 (not shown here—see FIG. 5) of a TIG orbital welding device (also: cassette). The welding head of the TIG orbital welding system is inserted into the cassette perpendicular to the welding point, wherein the non-consumable electrode in TIG orbital welding can be positioned vertically or at an angle with respect to the assembly to be joined, depending on the design of the welding system.

FIGS. 3a) and b) are a further example of welding between an MI line and a connecting part 2 by means of an annular element 3, in which an integral bond 100 is produced as a round seam 7. Unlike in FIG. 2, the annular element 3 is not pushed over the conductor element 1 as previously shown in FIGS. 2a) and b). Instead, an end section of the conductor element 1, in particular the MI line, to be welded is machined flat and the inner conductors 6 are released for other manufacturing steps. The annular element 3 is placed coaxially between the connecting part 2 and the conductor element 1 and clamped in a clamping device 11 (not shown here—see FIG. 5) as described above in conjunction with FIG. 2.

The two joining partners 1, 2 are pressed against each other so that the annular element 3 is held in place during welding. The annular element 3 is completely melted during welding and forms a weld pool with the material melted from the two joining partners 1, 2 and, after the weld pool has solidified, an intact butt seam 7 as a bond 100. If necessary, a shielding gas (externally supplied) and/or a forming gas (supplied from the inside of the connecting part 2) is supplied during welding. The welds shown are single-layer welds. The same welding procedures are used as for the fillet seam joints mentioned above (see above explained in conjunction with FIG. 2).

Of course, the invention also includes arrangements in which the annular element 3 encloses both a portion of the connecting part 2 and the conductor element 1, as in a sandwich (not shown). In this case, an inner surface of the annular element 3 borders both on a casing surface of the outer casing 4 (casing surface is first joining surface 41) and on a casing surface of the connecting part 2 as second joining surface 22, so that the round seam 7 is bead-shaped in this case.

Depending on the type of bond 100, a special shape of the annular element 3 can be selected. In the embodiments shown in FIG. 2a) and FIG. 3a), the annular element 3 has the shape of a rotation body of a rectangular cross-sectional area QF; further shapes are discussed below in conjunction with FIG. 4.

FIG. 4 is a perspective view of an annular element 3 as used in the method according to the invention. The annular element 3 comprises a main body which is designed as a rotation body. The rotation body is formed by an (imaginary) rotation of a cross-sectional area QF around an (imaginary) rotation axis RA, wherein the rotation axis RA lies in a plane with the cross-sectional area (QF) but does not intersect it. A distance AB between the rotation axis RA and a center point of the cross-sectional area QF is greater than a diameter DM of the cross-sectional area. In the design shown here, the cross-sectional area is round, so that the main body substantially has the form of a solid torus. The annular element 3 shown in FIG. 2a) and FIG. 3a), on the other hand, has a rectangular cross-sectional area QF of the main body. The cross-sectional area QF can of course also have forms other than those shown here and can be, for example, elliptical, square, or triangular (not shown).

In the case of a non-circular cross-sectional area QF, the person skilled in the art will use an alternative definition for diameter DM and/or center point. For example, the center point of a non-circular area corresponds to a geometric center of gravity. For example, the diameter DM of a non-circular area corresponds to a (maximum or minimum) diameter, in particular in the direction of the distance AB between the rotation axis RA and the cross-sectional area QF, or to a diameter of a circular area corresponding to the cross-sectional area QF, which circular area has the same area as the cross-sectional area.

The main dimensions of the annular element 3, such as a diameter DM of a cross-sectional area QF, for example a width and/or height h for the rectangular cross-sectional area QF shown in FIG. 2, an inner diameter and/or outer diameter, as well as further dimensions of the annular element 3 (FIG. 4) are designed depending on the material thicknesses to be welded, i.e., diameter of the conductor element 1, the connecting part 2, as well as the required thickness of the bond 100 designed as a round seam 7.

For example:
the diameter DM of the cross-sectional area QF is at least 0.05 times, in particular 0.1 times, as large as a wall thickness WM of the outer casing 4 and/or
the diameter DM of the cross-sectional area QF is at most as large as a wall thickness WM of the outer casing 4 and in particular less than 0.5 times the wall thickness WM and/or
the distance AB is at least three times, in particular at least five times, as large as the diameter DM.

Depending on the diameter of the outer casing 4 (in the range 0.5 mm to 10.0 mm), the wall thickness WM of the outer casing 4 is typically in the range 0.05 mm to 1 mm, which results in corresponding restrictions for the dimensions of the annular element 3.

For a 3 mm MI line, for example, the cross-sectional area QF of the annular element 3 has a diameter of 0.3 mm.

In the case of a welded joint, the selection of the material for the annular element 3 depends on the base materials of the two joining partners 1, 2. The annular element 3 is at least as highly alloyed as or more highly alloyed than the more highly alloyed of the two joining surfaces 41, 22. For example, the annular element 3 consists of a nickel-based alloy or, if the highest alloyed of the two joining partners is a stainless steel, of a stainless steel.

The annular element 3 is manufactured-depending on the shape-from a strip or sheet metal by means of suitable cutting processes, but preferably by laser beam cutting.

Other cutting processes are also feasible, including punching, water jet cutting, etc. The annular element 3 can be manufactured from a tube or rod by machining. For round cross-sectional areas QF, an annular element 3 can be made from a wire connected at both ends by welding. The annular element 3 can also be manufactured using suitable additive manufacturing processes, e.g., according to EN ISO 52900, see also FIG. 6.

Depending on the shape of the cross-sectional area QF for the construction of the main body of the annular element 3, materials that function as welding filler materials standardized in welding technology are preferred as starting material for the annular element 3. These include, for example, solid strip electrodes for submerged arc welding or electroslag welding, solid wires, and solid wire electrodes. For shapes with a cross-sectional area of QF that cannot be manufactured from the above-mentioned materials, semi-finished products such as tubes, round bars, hexagonal bars, etc., are used. The annular element 3 preferably has a good smoothness, for example an average roughness Rt of at most 16 μm (micrometers) and/or an average roughness Ra of at most 3.5 μm (micrometers). This is to ensure that it lies as flush as possible on the second joining surface 22 (fillet seam as round seam 7, FIG. 2c)—or on both joining surfaces 22, 41 (butt seam as round seam, FIG. 3b). In the case of a square cross-sectional area QF, it is also advantageous if the cross-sectional area QF is as close as possible to a rectangular shape, so that, for example, the end faces of the annular element 3 facing the connecting part 2 and the conductor element 1 are rather parallel-similar to one another. Parallel-similar means, for example, that the end faces are designed in such a way that they deviate from a parallel course by less than 30% of the diameter DM of the annular element 3, in particular in the direction of the rotation axis RA.

It is advantageous if the arrangement consisting of conductor element 1, connecting part 2 and annular element 3 is fixed before welding, for example to facilitate processing in a clamping device 11 (see FIG. 5). The clamping device is, for example, a rotating device or a stationary cassette; the latter in the case of a TIG circular welding system for the aforementioned TIG orbital welding. For this purpose, for example, the annular element 3 sits in a press fit on the conductor element 1 and/or the connecting part 2. This can be achieved, for example, by selecting a sufficiently small distance AB (or inner diameter of the main body) of the annular element 3 and/or by providing a gap 9 in the main body (rotation less than 360°, see FIG. 4). The gap 9 and/or the sufficiently small inner diameter (e.g., a maximum of 5% smaller than the outer diameter of the conductor element 1) enables the annular element 3 to be pushed onto, for example, the conductor element 1 in a press fit (e.g., by the inner diameter of the main body being smaller, in particular a maximum of 5% smaller, than the outer diameter of the conductor element 1). In this way, the annular element 3 forms a press and/or transition fit with the conductor element 1.

If necessary, the method also includes the following steps to be performed before joining,
fixing the annular element 3 at a predetermined joining position, in particular on the casing surface of the outer casing 4 and/or a lateral surface of the connecting part 2;
tacking the annular element 3 at the joining position, wherein during the tacking, the annular element 3 is only partially melted and only partially integrally connected to the conductor element 1 and/or the connecting part 2.

The tacking serves to temporarily connect the annular element 3 to the connecting part 2 and/or the conductor element 1. An assembly prepared for tacking comprises the conductor element 1, the connecting part 2, the annular element 3 and a tool 12, which is shown in more detail in FIG. 5. The arrangement shown in FIG. 5 otherwise corresponds to the arrangement already shown in FIG. 2a), in which the annular element 3 is pushed onto a selected position of the conductor element 1. To determine the joining position, an additional tool 12 is used as a stop. The tool 12 is also pushed onto the conductor element 1 and fixed there, for example by means of a screw and/or clamp. The tool 12 has the function of defining the position of the annular element 3 before tacking. In addition, the tool 12 ensures a planar, in particular gap-free, contact of the annular element 3 with the joining surfaces 22, 41, for example with the end face 22 of the connecting part 2, see FIG. 2a).

The tool 12 has recesses 12a at its tip to enable tacking and to prevent possible sticking of the tool 12 to the annular element 3. Before welding, the assembly comprising conductor element 1, annular element 3, connecting part 2 including the tool 12 is clamped in a clamping device 11, as explained above in conjunction with the welding.

This creates a tacking point (or tack seam) 15, which is later integrated into the weld (i.e., completely melted). The tacking is performed using either an arc or beam welding process, each without welding filler metal. If more than one tacking point (tack seam) is required, the assembly is moved (rotated) between each tack position either mechanically or manually on the side of the rotating device, or the non-consumable electrode is moved to the next tack position, in the case of TIG orbital welding. After tacking, the clamping device 11 is opened and the tool clamped on the conductor element 1 is released and removed. The assembly thus fixed (conductor element 1-connecting part 2-annular element 3) remains in the clamping device 11 of the welding device. The tacked assembly is realigned in the clamping device 11 and the clamping device 11 is closed again to allow the loose support and coaxial positioning of the tacked assembly during subsequent welding (as explained above in conjunction with FIG. 2).

For tacking, several projections or exactly one projection 8, which are arranged on an inner surface of the annular element 3 facing the joining surface(s) 22, 41, cf. FIG. 4, serve as tacking point.

In previous embodiments, the annular element 3 was always provided as a separately manufactured element. An alternative variant of the invention is shown in FIG. 6. In this, the annular element 3 is directly connected to the connecting part 2 during its manufacture. Thus, before joining, in particular welding, an assembly 10a; 10b comprising the annular element 3 and the connecting part 2 integrally connected thereto is obtained.

In a first embodiment of the latter variant, an assembly 10a is obtained by means of suitable additive manufacturing processes (also: 3D printing), e.g., according to EN ISO 52900. During its production, the annular element 3 is applied (or printed) directly onto the connecting part 2 by means of the additive manufacturing process and is directly integrally connected to the connecting part 2 during its production. As a manufacturing process, for example, a process is used that implements the material application of a starting material for the annular element 3 with directed energy input. The starting material is joined in several layers on the end face of the connecting part 2, which serves as the second joining surface 22. Processes with concentrated thermal energy are used to integrally connect the starting material directly to the connecting part 2 at the application site. The energy sources used are laser beam, electron beam, arc, plasma, or friction, and the additional materials used are, for example, metals in powder, wire, or rod form. In addition, for the application of the annular element 3 to the connecting part 2, methods can be used that work with powder bed based melting according to EN ISO 52900. For example, one of the following additive manufacturing processes is used: selective laser melting, electron beam melting, selective laser sintering. If necessary, the connecting part 2 and the annular element 3 are also manufactured in a common additive manufacturing process, e.g., using different materials.

In a second embodiment of the latter variant, an assembly 10b is produced by welding starting materials for the connecting part 2, in particular comprising a stainless steel, and the annular element 3 together in an initial welding process. This is done using a pressure welding process, particularly by means of diffusion welding, so that an initial assembly is formed. Here, the starting material for the annular element 3 is thin in a pressing direction, which is perpendicular to a welding surface of the pressure welding process, compared to the starting material for connecting part 2.

Subsequently, a manufacturing process from the main group of separating and/or forming, in particular machining, cutting, turning, drilling, is used, for example in combination with thermal separating processes such as plasma fusion cutting, laser beam cutting, and/or with other suitable forming separating processes, e.g., wire EDM (cutting EDM), in order to form the assembly 10b from the initial assembly. In this way, before the connecting part 2 and the conductor element 1 are joined, the annular element 3 and the connecting part 2 are already integrally connected to each other.

### REFERENCE SIGNS AND SYMBOLS

1 conductor element
2 connecting part
100 bond
110 assembly
21 guide
22 second joining surface
3 annular element
4 outer casing
41 first joining surface
5 inner conductor
6 insulating material
7 round seam
8 projection
9 gap
10a,10b assembly
11 clamping device
12 tool
15 tacking point
D outer diameter of 4
WM wall thickness of 4
QF cross-sectional area of 3
DM diameter of the QF
R rotation axis
ZA cylinder axis
AB distance

1-23. (canceled)

24. A method for producing a high-temperature-resistant integral bond, which is temperature resistant at temperatures of at least 380 °C, between a conductor element and a connecting part, the method comprising:
providing the conductor element, which includes:
a tubular element with an outer casing, which is metal;
at least one inner conductor arranged inside the tubular element;
an insulating material which is arranged inside the tubular element and which serves to electrically insulate at least the tubular element from the at least one inner conductor;
providing the connecting part, which is metal at least in regions and includes a guide for receiving the conductor element;
providing an annular element;
inserting the conductor element into the guide, wherein the conductor element inserted into the guide, the annular element, and the connecting part are arranged relative to each other such that the annular element abuts both:
a first joining surface of the outer casing, which is an end face and/or a casing surface of the outer casing, and
a second joining surface of the connecting part, which is an end face or a casing surface of the connecting part, which is metal and is cylindrical at least in portions; and
joining the conductor element and the connecting part by a thermal joining process, during which the annular element is completely melted and an integral bond is produced between the conductor element and the connecting part, whereby an annular round seam is formed therebetween.

25. The method according to claim 24, wherein the joining process comprises soldering, and
wherein during the soldering, the annular element serves as a lead-free, solder preform such that a solder connection is produced as the integral bond.

26. The method according to claim 24, wherein the joining process comprises welding, and
wherein during the welding, the annular element serves as a welding filler material such that a welded connection is produced as the integral bond.

27. The method according to claim 24, wherein the conductor element is a single-core or multi-core mineral-insulated conductor.

28. The method according to claim 24, wherein the annular element, the first joining surface, and the second joining surface are metal,
wherein the annular element is at least as highly alloyed as, or more highly alloyed than, the more highly alloyed of the first joining surface or the second joining surface, and
wherein the annular element consists essentially of a nickel-based alloy or a stainless steel.

29. The method according to claim 24, wherein the annular element comprises a main body, which is designed as a rotation body formed by an imaginary rotation of a cross-sectional area around an imaginary rotation axis,
wherein the rotation axis lies in a plane with the cross-sectional area but does not intersect the cross-sectional area,
wherein a distance between the rotation axis and a center point of the cross-sectional area is greater than a width of the cross-sectional area, and
wherein the cross-sectional area is round, elliptical, circular, angular, triangular, or rectangular.

30. The method according to claim 29, wherein at least one of:
the width of the cross-sectional area is at least 0.05 times as large as a wall thickness of the outer casing;
the width of the cross-sectional area is at most as large as the wall thickness of the outer casing and is less than 0.5 times the wall thickness; and
the distance is at least three times as large as the width.

31. The method according to claim 29, wherein the conductor element and the annular element are arranged relative to each other before joining such that the rotation axis substantially coincides with a cylinder axis of the conductor element.

32. The method according to claim 24, wherein the annular element is manufactured in the form of a separate element before joining and is subsequently provided.

33. The method according to claim 24, wherein the annular element is placed onto the casing surface of the outer casing and/or the casing surface of the connecting part before joining.

34. The method according to claim 24, wherein the annular element includes at least one projection which extends from an inner surface of the annular element in a direction of the first joining surface and/or the second joining surface, and
wherein the projection has a height in the direction of the first joining surface and/or second joining surface that is at most 0.1 times the width.

35. The method according to claim 29, wherein the main body is designed as a rotation body, which rotation body is formed by a rotation through an angle of less than 360° such that the main body includes a gap.

36. The method according to claim 24, further comprising, prior to joining the conductor element and the connecting part:
fixing the annular element at a predetermined joining position on the casing surface of the outer casing and/or a casing surface of the connecting part;
tacking the annular element at the joining position, wherein during the tacking, the annular element is only partially melted and only partially integrally connected to the conductor element and/or the connecting part.

37. The method according to claim 36, wherein the annular element includes at least one projection which extends from an inner surface of the annular element in a direction of the first joining surface and/or the second joining surface, and
wherein the at least one projection is as a tacking point for tacking the annular element at the joining position.

38. The method according to claim 24, wherein the annular element sits in a press fit on the casing surface of the outer casing and/or the casing surface of the connecting part before the joining.

39. The method according to claim 24, wherein the annular element is integrally connected to the connecting part or the conductor element during production of the annular element such that an assembly comprising the annular element and the connecting part or the conductor element integrally connected thereto is provided prior to joining the conductor element and the connecting part.

40. The method according to claim 39, further comprising, prior to joining the conductor element and the connecting part:
fabricating the annular element by an additive manufacturing process, wherein the annular element is fabricated directly on the connecting part and/or the conductor element at a predetermined joining position, whereby the assembly is provided.

41. The method according to claim 39, further comprising, prior to joining the conductor element and the connecting part:
providing a starting material for the annular element;
providing a starting material for the connecting part, which comprises a stainless steel;
initially welding the starting material for the annular element with the starting material for the connecting part in a pressure welding process, whereby an initial assembly is formed,
wherein the starting material for the annular element has a smaller thickness in a pressing direction than a thickness of the starting material for the connecting part in the pressing direction, which pressing direction is perpendicular to a welding surface of the pressure welding process, and
wherein the thickness of the starting material for the annular element is at most 0.1 as large as the thickness of the starting material for the connecting part in the pressing direction; and
manufacturing the annular element and the connecting part integrally connected thereto from the initial assembly by a manufacturing process of a main group of separating and/or forming, including machining, cutting, turning, and/or drilling,
whereby, before joining, the assembly comprising the annular element and the connecting part integrally connected thereto is obtained from the initial assembly.

42. The method according to claim 24, wherein the round seam between the conductor element and the connecting part is formed as a fillet seam, butt seam, or a bead-shaped seam.

43. The method according to claim 24, further comprising, after inserting the conductor element into the guide and before joining or before tacking and joining:
clamping an arrangement consisting of the conductor element, the connecting part and the annular element in a clamping device; and
wherein the clamping device is a rotating device, rotating the arrangement; or
wherein a movable energy source is used for welding and/or tacking, rotating the energy source used around the assembly during welding and/or tacking.

44. The method according to claim 43, wherein the tacking and/or welding is performed in a fusion welding process, in particular, an arc welding process, in particular using a non-consumable electrode, or in a beam welding process.

45. The method according to claim 26, wherein the welding is free from the use of any further welding filler material different from the annular element.

46. The method according to claim 26, further comprising:
using an energy source during welding, wherein the energy source is directed onto an arrangement consisting of the conductor element, the connecting part, and the annular element such that energy emitted by the energy source in the direction of the arrangement is more than 85% absorbed by the annular element.

47. A high-temperature-resistant assembly, which is temperature-resistant at temperatures of at least 380 °C, comprising:
a conductor element and a connecting part, including a high-temperature-resistant integral bond between the conductor element and the connecting part,
wherein the high-temperature-resistant, integral bond is produced by a method according to claim 24.
